(19) United States
(12) Patent Application Publication
(10) Pub. No.: US 2020/0306809 A1
(43) Pub. Date: Oct. 1, 2020

(54) METHOD FOR OPERATING A ROLLING TECHNOLOGY OR METALLURGICAL SYSTEM

(71) Applicant: SMS group GmbH, Düsseldorf (DE)

(72) Inventors: Johannes ALKEN, Siegen (DE); Hartmut PAWELSKI, Ratingen (DE); Daniel KNIE, Freudenberg (DE); Markus SCHELLMANN, Siegen (DE)

(73) Assignee: SMS group GmbH, Düsseldorf (DE)

(21) Appl. No.: 16/644,481

(22) PCT Filed: Sep. 4, 2018
(86) PCT No.: PCT/EP2018/073708

§ 371 Date: Mar. 4, 2020

(30) Foreign Application Priority Data
Sep. 6, 2017 (DE) 10 2017 215 713.5

(51) Int. Cl. B21B 27/06; F16C 33/10; B21B 31/07; C10M 145/40; C10M 173/00; C10M 169/06

(52) U.S. Cl. CPC B21B 27/06; F16C 33/109; B21B 31/074; F16C 17/14; C10M 173/00; C10M 169/06; C10M 145/40

(57) ABSTRACT

A method for operating a rolling technology or metallurgical system is disclosed. The rolling technology or metallurgical system comprises a device in which a rotating component is mounted with at least one sliding bearing. The sliding bearing is supplied with a lubricant. In order to enable improved operation of said bearings, in particular in rolling mills, a water-based, single-phase fluid to which at least one viscosity-increasing additive is added is used as the lubricant for the bearing.

### TECHNICAL FIELD

The disclosure relates to a method for operating a hot or cold rolling mill in a rolling technology or metallurgical system. The hot or cold rolling mill comprises a plurality of roll stands with support rolls that are mounted with at least one sliding bearing. The sliding bearing is supplied with a lubricant.

### BACKGROUND

Rolls with sliding bearings in a roll stand are described, for example, in U.S. Pat. No. 2,200,837 A. U.S. Pat. No. 2,575,830 A shows a similar solution. U.S. Pat. No. 4,043,925 A discloses a lubricant mixture with a special composition.

Sliding bearings, as they are typically used in rolling and metallurgical technology in hot and cold strip rolling mills, use oils as lubricants, wherein mineral oils are preferably used. The viscosity of the oil provides a sufficient lubricating film that reliably separates the rotating parts from the stationary parts. In the sliding process, heat is generated by the internal viscous friction, which leads to an increase in the oil temperature and a decrease in the viscosity of the lubricating oil. This in turn inevitably leads to a reduction in the load carrying capacity of the sliding bearing.

An additional task of the lubricant is to dissipate the heat generated from the bearing.

The following circumstances are disadvantageous with the previously known procedure:

Mineral oils typically used in sliding bearings can cause leaks and, for example, cooling water from the rolling process can enter the circuit of the bearing. This can cause damage to it. In order to avoid this, the lubricating oil for the sliding bearing must be drained in a complex and expensive process, in order to prevent water that does not mix with the oil from causing bearing damage. In addition, the water separation process reduces the durability of the oil.

On the other hand, leaks in the sliding bearing can cause oil from the sliding bearing circuit to enter the rolling process. The undefined and unintentional lubrication of the roll gap (in this case, the oil runs over the support roll onto the work roll, for example) can lead to process instabilities or impair product quality.

In cold rolling mills, the mixing of low-viscosity rolling oil with high-viscosity sliding bearing oil impairs the lubrication in the roll gap and leads to unfavorable evaporation. In addition, residues of the highly viscous sliding bearing oil on the rolled product can lead to problems in the further processing of the same, for example in the annealing process.

An additional problem is that the mineral oil from the sliding bearing can burn on the hot rolled material surface.

### SUMMARY

Therefore, the disclosure is based on the task of proposing a method of the kind mentioned above that can solve the problems mentioned above. In particular, it should be possible to improve operation in rolling mills without being disturbed by the problems identified.

The solution of this task is characterized in that a water-based, single-phase fluid to which at least one viscosity-increasing additive is added is used as a lubricant for the sliding bearing. A biopolymeric material is added to the water as an additive, wherein the biopolymeric material is in particular cellulose, starch and/or bacterial polysaccharides, or a salt of modified cellulose is added to the water as an additive as the sole polymeric lubricant.

The water content in the lubricant is preferably at least 50 percent by volume.

At least one additional functional additive can be added to the fluid. Thereby, for example, a corrosion protection improver or lubrication improver that can be added to the fluid can be considered.

Finally, a lubricant thickener can be added to the water, wherein this is selected from the group consisting of metal soaps of mono- and/or dicarboxylic acids, ureas, phyllosilicates, solid lubricants and Aerosil.

Instead of the mineral oil typically used in sliding bearings, in particular on support roll bearings in rolling mills, a single-phase, water-based lubricant with additives is used. The desired viscosities can be adjusted by means of additives.

Since the lubricating medium is now water-based, it has a higher heat capacity along with a higher density compared to the mineral oils previously used. This leads to improved heat dissipation from the lubrication gap of the sliding bearing. In addition, the water-based lubricant offers a significantly lower temperature dependence of the viscosity. The single-phase medium can be finely filtered very well, for which multi-phase emulsions are not suitable.

The proposed approach offers various advantages, which are particularly, but not exclusively, noticeable when used on support roll bearings of rolling mills:

The mixing of the water-based, single-phase lubricant with process water (for example, cooling water) is much less critical, since the working fluid of the sliding bearing is water-based. Only the concentration of the additives must be corrected.

A leakage of the single-phase, water-based sliding bearing medium has less influence on the cold rolling process and no influence on the hot rolling process.

In contrast to mineral oil, the single-phase, water-based sliding bearing medium is non-flammable, which is particularly advantageous for hot rolled material surfaces.

The circuit of the bearing lubrication can also be made smaller to improve heat dissipation. This applies in particular to the tank size and pipe cross-sections along with the installed pump capacity.

Water-based lubricants are known as such and can be used for the proposed process. In particular, explicit reference is made to DE 10 2009 039 626 A1, WO 2009/106359 A1, CN 102010780 B and CN 101718297 B, where corresponding water-based lubricants suitable for use here are described in detail.

1.-11. (canceled)

12. A method for operating a hot or cold rolling mill train in a rolling technology or metallurgical system, comprising:
providing, in the hot or cold rolling mill train, a plurality of roll stands with support rolls that are each mounted with at least one sliding bearing; and
supplying a lubricant to each sliding bearing, the lubricant being a water-based, single-phase fluid to which at least one viscosity-increasing additive is added, the additive being a biopolymeric material.

13. The method as in claim 12,
wherein the biopolymeric material is cellulose, starch and/or bacterial polysaccharides.

14. The method as in claim 12,
wherein a salt of modified cellulose is added to the water as the additive and sole polymeric lubricant.

15. The method according to claim 12, wherein a water content in the lubricant is at least 50 percent by volume.

16. The method according to claim 12, wherein at least one additional functional additive is added to the fluid.

17. The method according to claim 12, wherein a lubricant thickener is added to the water, the lubricant thickener being selected from the group consisting of metal soaps of mono- and/or dicarboxylic acids, ureas, phyllosilicates, solid lubricants, and Aerosil.
